(19) United States
(12) Patent Application Publication
(10) Pub. No.: US 2007/0162322 A1
(43) Pub. Date: Jul. 12, 2007

(54) Social calendar

(75) Inventors: Omar H. Shahine, San Francisco, CA (US); Ann M. Hudspeth, Redmond, WA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/328,633

(22) Filed: Jan. 10, 2006

(51) Int. Cl. G06F 15/02

(52) U.S. Cl. 705/9

(57) ABSTRACT

A social calendar is provided for managing social events. A social calendar application provides an interface which allows a user to manage events during social time periods. The interface emphasizes social periods in multiple-day views. The emphasis on social periods may be implemented by allocating more scheduling bandwidth to social time periods then other periods, such as work periods. The social calendar interface allows for event scheduling in scheduling modules. Scheduling modules may include primary scheduling modules and/or secondary scheduling modules.

### BACKGROUND

Electronic personal information manager (PIM) applications and calendar applications are typically used for business purposes. These applications cater to users in a business environment and allow users to manage business events. Typically, these products are used by businesses having several users, and allow the users to coordinate and manage tasks during business hours. For example, most PIM and calendar applications allow users to schedule meetings with other networked users during a business day and view events scheduled within typical business hour for a work day, week or month.

PIM and calendar applications provide limited display options for days within a work week. Most of these applications provide a calendar for a business day, a business week (e.g., Monday through Friday), a full week, or a month. When more than one day is illustrated within an interface, the calendars typically provide the same emphasis on each business day.

### SUMMARY

These present technology, roughly described, pertains to a calendar application (social calendar) for managing social events. The social calendar provides an interface which allows a user to manage events during social time periods of one or more days, weeks or months. In one embodiment, the interface allows a user to manage events within social time periods such as evenings of week days and the entire day of weekends. A social time period may be a period in which a user of the social calendar typically does not work.

In one embodiment, the social calendar application provides an interface which emphasizes social periods in multiple-day views. In this case, social periods such as weekday evenings and weekend days include more scheduling bandwidth than business periods associated with less social time. The bandwidth is provided through primary and secondary scheduling modules associated with different periods of time, such as a day, week or month. In another embodiment, the social calendar may provide a view for managing social events for multiple weekends without displaying the intervening business days.

Events associated with a social calendar can be configured as non-business type events. For example, events for a social calendar may include dinner appointments, concerts, athletic events and other events typically associated with non-business hours. Each of these social events may be configured as an event object. The event object may include parameters and meta-data which can be configured by a user. The event object may then be retrieved and displayed by the calendar application providing the calendar view.

The social calendar may be implemented as a client application or a network-based application. A client calendar application can store user calendar data locally on the client device. In this case, event objects associated with different social events may be added, changed and removed from the local client device as a user configures his or her calendar. A network-based social calendar may save user calendar data remotely. In particular, the social calendar may be implemented using a calendar application or browser application on a client device which can access a remote server over a network. When implemented using a browser application, the application may access a web service provided by one or more web servers and/or related devices. When provided over a network, the social calendar allows the user to schedule and share events with other users, view log in status and other information for other users, and other information.

This summary is provided to introduce a selection of concepts in a simplified form that are further described below in the description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1A illustrates a block diagram of an embodiment of a system for providing a social calendar by a client application.

FIG. 1B illustrates a block diagram of an embodiment of a system for providing a social calendar by a browser application.

FIG. 2 illustrates a block diagram of an embodiment of a computing environment for implementing the present technology.

FIG. 3 illustrates a flowchart of an embodiment of a process for providing a social calendar.

FIG. 4A illustrates a flowchart of an embodiment of a process for constructing and providing a social calendar interface.

FIG. 4B illustrates a flowchart of an embodiment of a process for processing an event object.

FIG. 5 illustrates a flowchart of an embodiment of a process for adjusting a calendar interface.

FIG. 6 is an example of a social calendar interface for a user.

FIG. 7 is an example of a network-based social calendar interface for a user.

FIG. 8 is an example of a network-based social calendar interface for a user.

FIG. 9 is another example of a social calendar interface for a user.

### DETAILED DESCRIPTION

A calendar application is provided for managing social events. The social calendar provides a user configurable interface. The interface allows a user to manage events during social time periods of one or more days, weeks or months. The social periods include week day evenings, weekends and other social periods. In one embodiment, a social time period is a period in which the user typically does not work. For example, for a user that typically works 9 a.m. to 5 p.m. Monday through Friday, social time periods of the user would be weekdays after 5 p.m. and all day on weekends.

In one embodiment, the social calendar application provides an interface which emphasizes social periods in multiple-day views. The emphasis on social periods may be implemented by allocating more scheduling bandwidth to social time periods then other periods, such as work periods. More scheduling bandwidth may include more interface space, more inclusive time lines, more event categories available for selection, and other interface features.

In one embodiment, the social calendar interface allows for event scheduling in scheduling modules. For example, a scheduling module may be associated for each day displayed in an interface view. Thus, for an interface providing a week view, there may be seven scheduling modules, one module associated with each day in the week.

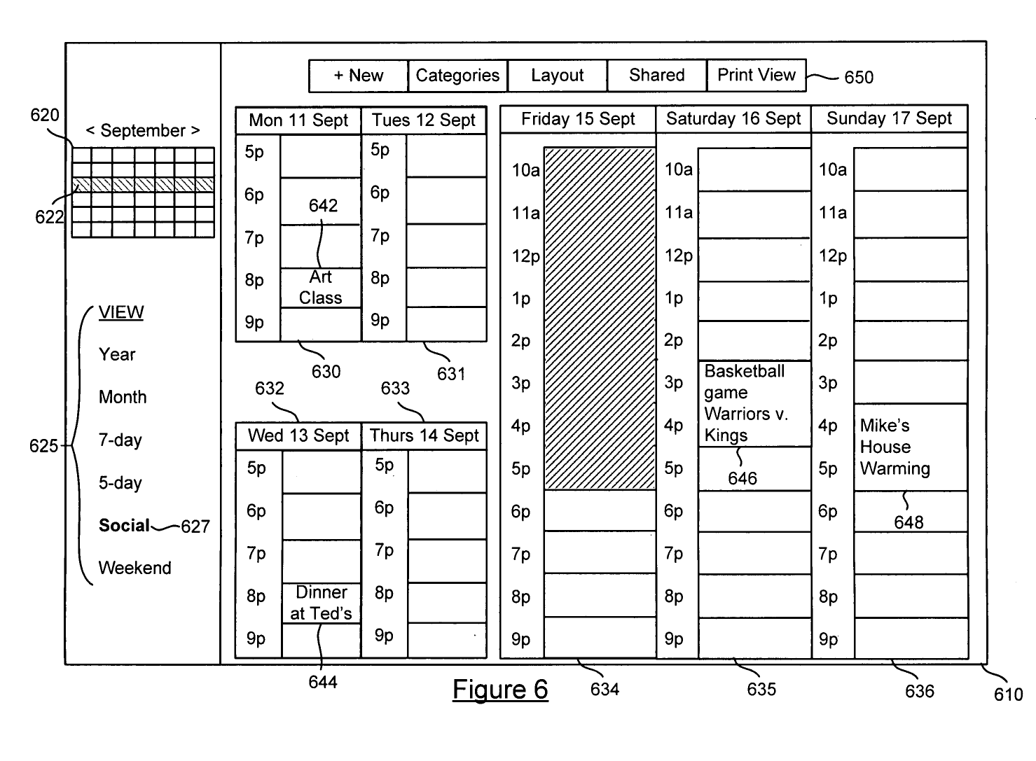

Scheduling modules may include primary scheduling modules and secondary scheduling modules. A primary scheduling module may have more scheduling bandwidth then a secondary scheduling module. For example, a primary scheduling module may be associated with a full weekend day, while a secondary scheduling module may be associated with evening hours of a weekday. As such, the primary scheduling module may allow social event scheduling of event objects from 10 a.m. to 9 p.m. and the secondary scheduling module may allow social event scheduling of event objects from 6 p.m. to 9 p.m. Additionally, a primary scheduling module may comprise more space within the interface than a secondary scheduling module. Since the primary scheduling module is associated with a longer time period over which events can be scheduled and/or more space within a social calendar interface than a secondary scheduling module, the primary scheduling module is considered to have a larger bandwidth than the secondary scheduling module. Scheduling modules are illustrated in FIGS. 6-9 and discussed in more detail below.

Events associated with a social calendar can be configured by a user. For example, events for a social calendar may include dinner appointments, concerts, athletic events and other events which typically occur outside the normal business hours of about 9 a.m. to 5 p.m. Each of these social events may be configured as an event object. The event object may include data, such as event parameters and other meta-data, which can be configured by a user. In one embodiment, a user may enter event object data through an interface provided by the calendar application. The event object may then be displayed, stored and later retrieved or deleted by the calendar application.

The social calendar may be implemented on a client device or over a network. When implemented on a client device, the social calendar is provided by a calendar client application. The client application reads and writes calendar data from client device memory. When implemented over a network, at least a portion of the user data for the social calendar is stored on a remote server. In this case, the social calendar may be provided using a client application which accesses the remote server or through a browser application which accesses a web server providing a content page. In the case of a browser application, the content page provides the calendar interface. When provided over a network, the social calendar allows the user to schedule and share events with other users, view log in status and other information for other users, and other information.

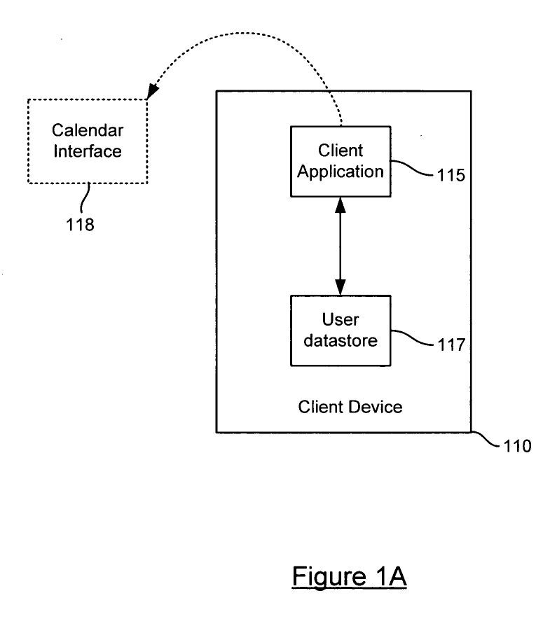

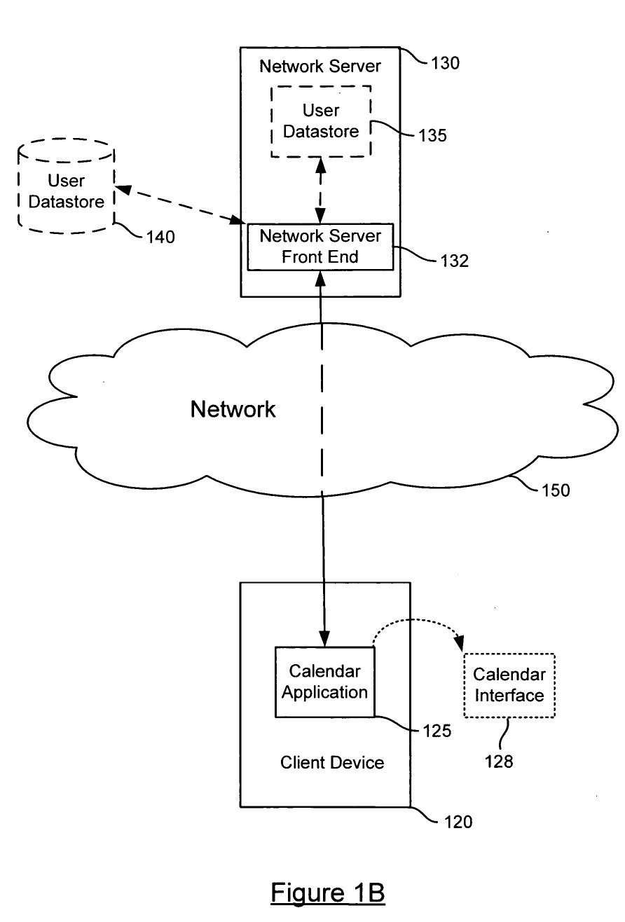

The social calendar of the present technology is discussed in more detail below. In particular, systems and methods associated with social calendar functionality and operation are discussed below with respect to FIGS. 1-5. Examples of social calendar interfaces are discussed below with respect to FIGS. 6-9.

FIG. 1A illustrates a block diagram of an embodiment of a system for providing a social calendar by client application 115. The system of FIG. 1A provides a social calendar implemented on a client device 110. FIG. 1A depicts client application 115 and user datastore 117 implemented on client device 110.

Client application 115 may communicate with user datastore 117 within client device 110. In one embodiment, client application 115 may be implemented as a calendar application, PIM application or some other application which allows a user to manage a social calendar. Client application 115 also provides calendar interface 118, as indicated by the dotted lines in FIG. 1A. The calendar interface is provided through a display device associated with client device 110. Examples of a calendar interfaces are discussed in more detail below with respect to FIGS. 6-9.

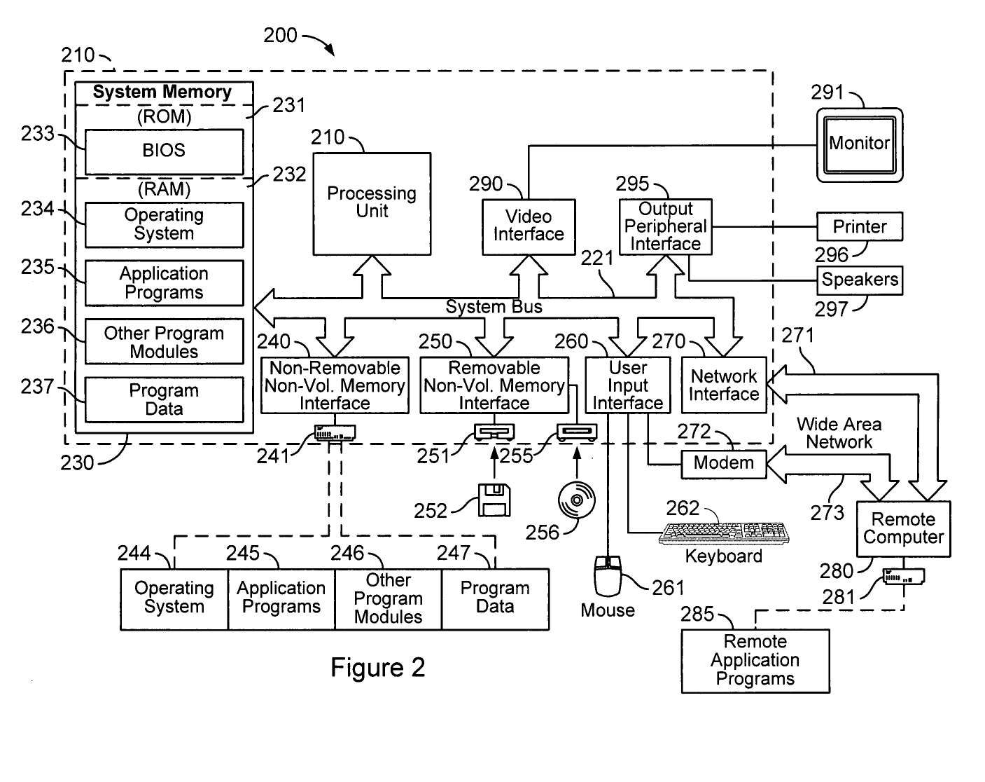

User datastore 117 includes user data associated with the social calendar. The user data may include event object data associated with the user, user authentication information, calendar parameters configured by the user, and other data used to configure or populate a calendar interface or otherwise associated with the user. In one embodiment, user datastore 117 may be implemented by local memory of client device 110. Local memory of client device 110 is discussed in more detail below with respect to the computing environment of FIG. 2.

FIG. 1B illustrates a block diagram of an embodiment of a system for providing a social calendar over a network. The system of FIG. 1B is an example of a system for implementing a social calendar over a network. FIG. 1B includes client device 120, network server 130, and network 150. FIG. 1B may optionally include user datastore 140.

Client device 120 includes browser application 125. Browser application 125 communicates with network server 130 over network 150. In one embodiment, network 150 may be implemented as the Internet. Though the system of FIG. 1B includes a browser application on client device 120, other applications could be used to implement a social calendar and access user calendar data from a server over a network. Examples of other applications for implementing a social calendar include a PIM application, a client calendar application which accesses data over a network, and other applications.

Browser application 125 may communicate with network server 130 to retrieve and provide content pages. In one embodiment, browser application 125 may provide calendar interface 128 as a content page. In an embodiment wherein another type of application is used to provide a social calendar and access data from a server over network 150, the particular application would provide calendar interface 128.

Network server 130 includes network server front-end 132 and can optionally include user datastore 135. Network server front-end 132 receives and transmits messages from requesting client devices, such as client device 120. The received messages may include content requests, authentication requests, and other messages. The messages sent by network server front-end 132 may include content responses sent in response to a request, authentication responses, and other messages. Network server frontend 132 provides the social calendar functionality described herein. Operation of network server front-end 132 is discussed in more detail below.

Network server front-end 132 may also access user datastore 135. User datastore 135 is optional, as indicated by the dashed lines comprising user datastore 135 in FIG. 1B. In one embodiment, network server front-end 132 may access remote user datastore 140. User datastore 140 is also optional, as indicated by the dashed lines comprising the datastore. In some embodiments, network server front-end 132 may access either or both datastores. Whichever datastore is used, user calendar data can be added, removed, changed and processed at each data store. As discussed above, user calendar data (or user data) may include event object data, user authentication data, calendar parameter and settings data, and other user data associated with a social calendar.

FIG. 2 illustrates an example of a suitable computing system environment 200 on which the present technology may be implemented. The computing system environment 200 is only one example of a suitable computing environment and is not intended to suggest any limitation as to the scope of use or functionality of the technology. Neither should the computing environment 200 be interpreted as having any dependency or requirement relating to any one or combination of components illustrated in the exemplary operating environment 200. In one embodiment, the computing environment of FIG. 2 may be used to implement client device 110, client device 120, network server 132 and/or user datastore 140.

The present technology is operational with numerous other general purpose or special purpose computing system environments or configurations. Examples of well known computing systems, environments, and/or configurations that may be suitable for use with the present technology include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The present technology may be described in the general context of computer-executable instructions, such as program modules, being executed by a computer. Generally, program modules include routines, programs, objects, components, data structures, etc. that perform particular tasks or implement particular abstract data types. The present technology may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system for implementing the present technology includes a general purpose computing device in the form of a computer 210. Components of computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or present technology for storage of information such as computer readable instructions, data structures, program modules or other data. Computer storage media includes, but is not limited to, RAM, ROM, EEPROM, flash memory or other memory present technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates a hard disk drive 240 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 20 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through an output peripheral interface 290.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

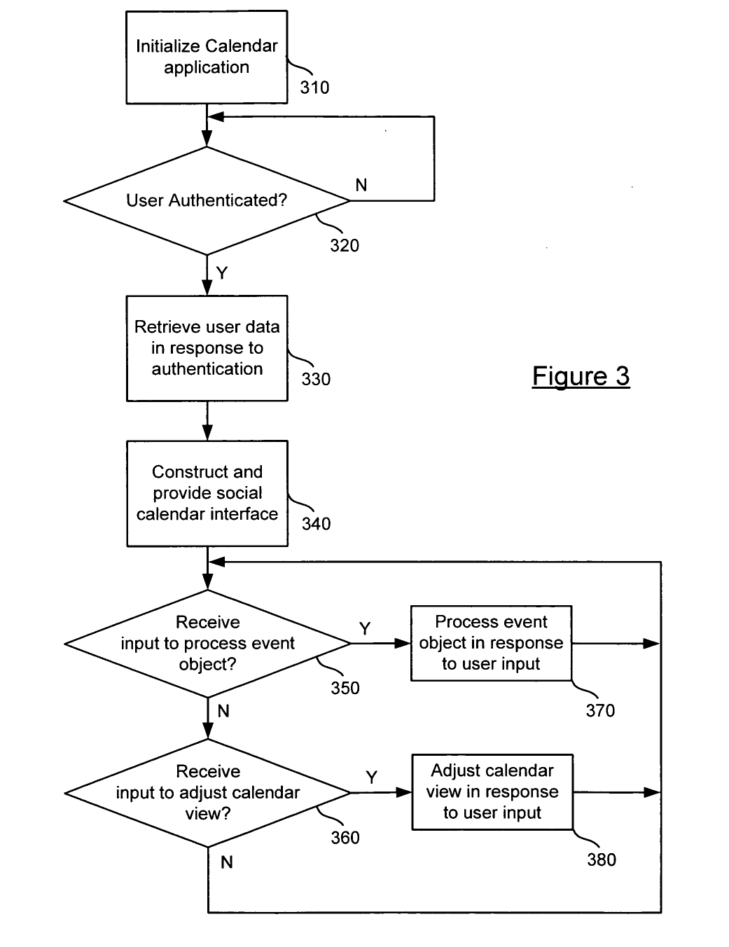

FIG. 3 is a flowchart of an embodiment of a process for providing a social calendar. The flowchart of FIG. 3 may be used to implement a social calendar locally on a client device as discussed with respect to client device 110 or by with an application such as browser application 125 which accesses user data over a network.

First, a calendar application is initialized at step 310. Initializing a calendar application involves starting up the application which provides the calendar interface. If the application accesses data over a network, initializing the application may include detecting a network connection on the client device on which the application resides. Next, a determination is made as to whether a user is authenticated at step 320. In one embodiment, after initializing the calendar application at 310, the calendar application will provide an authentication interface to a user. The authentication interface may allow a user to enter a user name, password, and/or other authentication information. Once a user name and password are received, the calendar application may confirm that the user name and password match information stored in the appropriate user datastore. If the user name and password information received from a user matches user and password information stored in a datastore, then the user is authenticated.

In the case of a locally implemented calendar application, the user name and password are compared with data stored in user datastore 117 on client device 110. If user data is accessed over network 150, the application determines if the received user name and password match user name and password information stored on user datastore 135 or user datastore 140. In this case, an authentication request is sent to network server 130 by client device 120. Network server front end 132 receives the authentication request and sends an authentication request to user datastore 135 or user datastore 140. The appropriate user datastore receives the request, determines if the username and password match user data stored in the user datastore, and provides an authentication response to network server front end 132. The authentication response indicates whether the authentication was successful. Network server front end 132 forwards the authentication response to the requesting client device 120.

If the user name and password information received from a user matches user and password information stored in a datastore, then the user is authenticated and the flowchart of FIG. 3 continues to step 330. If the user is not authenticated at step 320, the flowchart remains at step 320.

User data is retrieved in response to the authentication at step 330. In one embodiment, the user data retrieved can be associated with a default interface or the last calendar view provided in the calendar interface. The data may be retrieved from local datastore 117 or remote user datastore 135 or 140 depending on the implementation of the calendar application. In the case of a local datastore, client application 115 retrieves the user data from user datastore 117. When accessed from local user datastore 117, the user data may include a series of files. Each file may include data associated with an event object for a user. For example, an event object may include data for a dinner appointment, a sporting event, a wedding, or some other social event associated with the user.

User data may also be retrieved from remote datastores 135 and/or 140. In the case of a network-based calendar application, browser application 125 may request the user data from network server 130. Network server 130, or network server front end 132, may process the request similar to the authentication request discussed above. However, instead of comparing received user authentication information to stored user authentication information, the appropriate user datastore retrieves requested user data and places the data in a response. The response is then sent to network server front end 132, which receives the response ands sends it the requesting application.

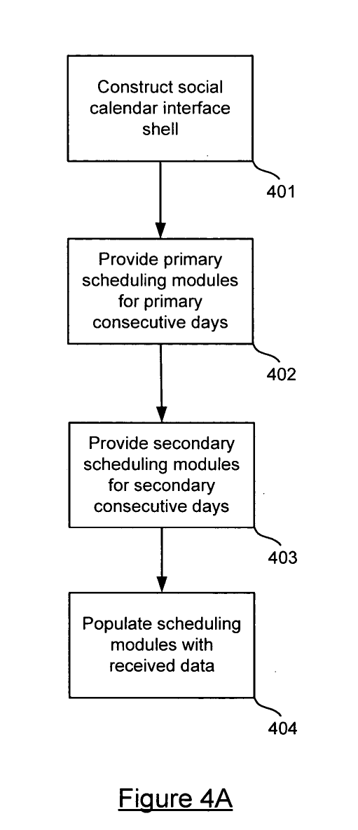

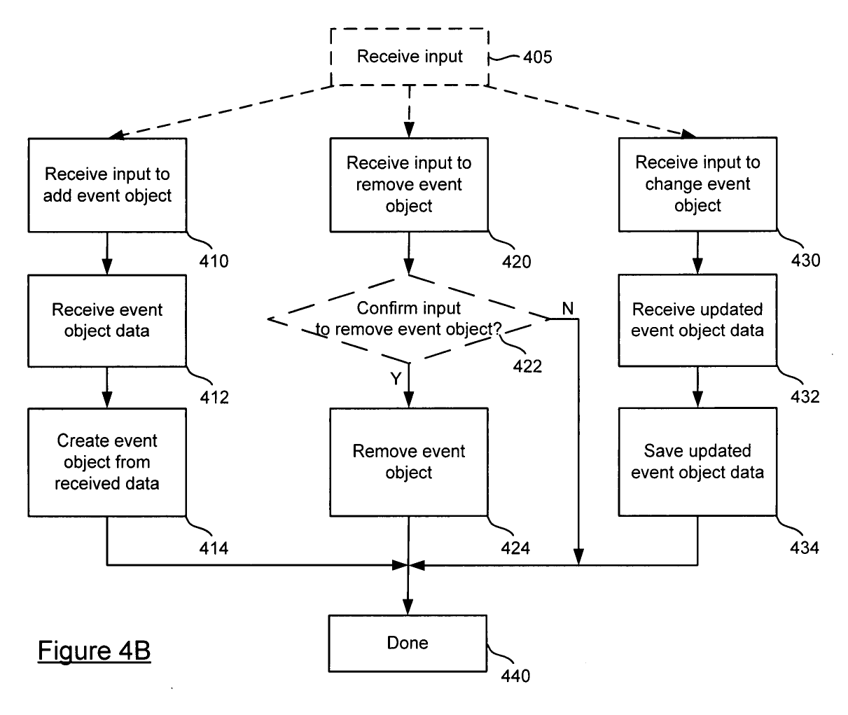

After user data has been retrieved, the social calendar interface is constructed and provided at step 340. In one embodiment, the social calendar interface is constructed and populated with the retrieved data. In one embodiment, the constructed interface may be a default calendar interface or the last interface accessed by the user. In any case, the interface is provided with one or more primary scheduling modules, one or more secondary scheduling modules, a combination thereof. Once the interface is constructed, the event objects associated with the user are populated within the interface. Constructing and providing the social calendar interface is discussed in more detail below with respect to FIG. 4A.

After constructing and providing the social calendar interface, a determination is made as to whether input is received to process event objects at step 350. In one embodiment, receiving input to process an event object includes receiving input to add, change or delete an event object. If input is received to process an event object at step 315, the flowchart of FIG. 3 continues to step 370. Event objects are processed in response to user input at step 370. Processing the event object may include adding, removing or changing the appropriate event object and updating the social calendar interface in response to processing the object. Processing the event object at step 370 is discussed in more detail below with respect to FIG. 4B. After the event object is processed, the flowchart of FIG. 3 returns to step 350. If input is not received to process an event object at step 350, the flowchart of FIG. 3 continues to step 360.

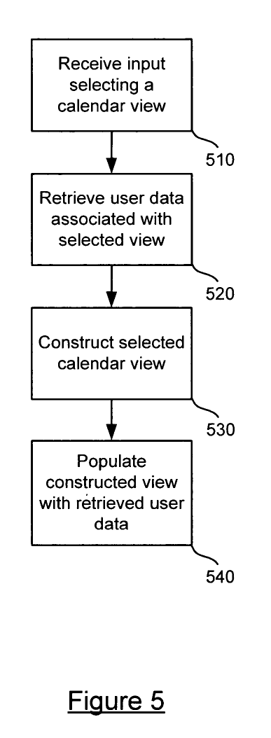

A determination is made as to whether input is received to adjust a calendar view at step 360. Receiving input to adjust a calendar view may be associated with changing the actual calendar view or calendar view parameters. Changing the actual view may include providing a social view, weekend view, multiple weekend view, or other calendar view within the calendar interface. If input is received to adjust a calendar view, the flowchart of FIG. 3 continues to step 380 where the calendar view is adjusted in response to the user input. Adjusting the calendar view in response to user input is discussed in more detail below with respect to FIG. 5. After the calendar view is adjusted, the flowchart of FIG. 3 continues to step 350. If no input is received to adjust a calendar view at step 360, the flowchart of FIG. 3 returns to step 350.

FIG. 4A illustrates a flowchart of an embodiment of a process for constructing and providing a social calendar interface. In one embodiment, FIG. 4A provides more detail of step 340 of FIG. 3. First, a social calendar interface shell is constructed at step 401. The interface shell may include a various menu elements, such as a view menu, and other base elements in the interface. Next, primary scheduling modules are provided for one or more primary consecutive days at step 402. In this case, a module which provides for social scheduling is provided within the social calendar interface (the interface shell). Next, secondary scheduling modules are provided for one or more secondary consecutive days at step 403. Similar to step 402, the one or more secondary scheduling modules provide for social event scheduling. In one embodiment, a primary day may differ from a secondary day in that a primary day is associated with a longer social period. For example, a weekend which is not associated with any work has a longer social period (all day) then a weekday in which work is typically scheduled during the daytime.

In some embodiments, steps 402 and 403 may be repeated or skipped. For example, one embodiment of a social calendar may provide primary scheduling modules associated with consecutive weekends. In this case, the calendar interface may include two sets of consecutive primary modules associated with weekends and no secondary modules associated with the intervening weekdays. In this case, step 403 is not performed.

After providing modules in the social calendar interface, the scheduling modules are populated with received data at step 404. Populating the scheduling modules includes populating any primary and secondary scheduling modules with user data retrieved at step 330 of FIG. 3. In particular, visual indicators are placed within the scheduling modules to correspond to object events associated with the user. Social calendar interfaces are discussed in more detail below with respect to FIGS. 6-9.

Providing the data in a social calendar interface includes constructing the interface and populating the interface with the retrieved data. In one embodiment, the constructed interface may be a default calendar interface or the last interface accessed by the user. Once the interface is constructed, the event objects associated with the user are populated within the interface. As discussed above, event objects are a set of data and/or information which can be displayed in the interface and are associated with a social event. For example, event objects associated with user appointments are retrieved at step 330 and placed into the interface. Examples of populated calendar interfaces are illustrated in FIGS. 6-9 and discussed in more detail below.

Event objects provided within a calendar interface may be configured in response to user input. FIG. 4B is a flowchart of an embodiment of a process for processing an event object. In one embodiment, the flowchart of FIG. 4B provides more detail of step 370 of FIG. 3 discussed above.

The flowchart of FIG. 4B is associated with processing an event object in response to receiving input. Several types of input may be received from a user through a calendar interface. Types of input that may be received include input to add event object data, remove event object data, and change event object data. The input can be received through a drop down menu, command line, selection of an icon or other element of an interface, or in some other manner. Input received to add an event object, remove an event object, and change an event object are discussed below with respect to steps 410, 420 and 430, respectively, of the flowchart to FIG. 4B.

Input is received to add an event object at step 410. In one embodiment, input to add an event object may be received through a calendar interface as a selection of a particular time slot or block within a calendar interface, a selection of an element within a drop down menu, a selection of an icon, or some other input. Next, event object data is received at step 412. The event object data is received from a user. In one embodiment, receiving event object data may include providing an interface in response to the input received at step 410. The interface may allow a user to input data associated with the event object. For example, the interface may allow user to select a category for an event object. Exemplary event object categories may include dinner appointment, sporting event, party and other events. The interface may then allow a user to enter meta-data regarding the event object into the interface. The meta-data may include general data and/or data tailored to the particular event. For example, for a dinner event, the entered meta-data may include a name for the event, name of the restaurant, location of the restaurant, a name under which a dinner reservation is made and other information.

After the event object data is received, an event object is created from the received data at step 414. In the case of a calendar application implemented entirely on client device 110, the event object data is saved by client application 115 to user datastore 117. After the data is stored to user datastore 117, an event object may be provided in the current calendar interface if appropriate. For example, the event object will be displayed in the calendar interface if the event object corresponds to a time currently provided in the calendar interface view.

For a calendar application in which the event object is saved remotely, creating the event object from the received data includes storing the event object data on a datastore associated with a network server. With respect to FIG. 1B, browser application 125 will send the event object data in a write message to network server 130. Network server front-end 132 receives the write message and forwards the write to either user datastore 135 or user datastore 140. In one embodiment, when stored at a remote datastore, user event object data is stored in a table format. The table may include user identification information and event object data associated with the user identification information. After receiving a confirmation that the data is stored on the appropriate datastore, network server front end 132 sends a confirmation to browser application 125 that the event object data has been stored. In addition to sending the event object data to a remote datastore, browser application 125 can provide the received event object data in the current interface if the event object data is associated with a time included in the current calendar view. After the event object is created from the received data at step 414, the flowchart of FIG. 4B ends at step 440.

Input is received to remove an event object at step 420. The input may be received as a selection from a drop down menu associated with the event object, selection of an icon or some other input within the calendar interface. A determination is then made as to whether a user has confirmed to remove the event object at step 422. Step 422 can be optionally performed to confirm that the object event should be removed from the calendar interface and appropriate user datastore. In one embodiment, step 422 includes providing a user prompt inquiring whether the user wishes to remove the object data, as well as buttons for removing or not removing the object. User selection of the one of the buttons satisfies the determination as to whether the user confirms removal of the event object. If confirmation input is received that the event object should be removed, the flowchart of FIG. 4B continues to step 424. If input indicates that the event object should not be removed (or no input is received at all), the flowchart of FIG. 4B ends at step 440.

At step 424, the event object is removed. Removing the event object may include removing the actual object data from the calendar interface and deleting the data from the appropriate datastore. In the case of a social calendar implemented entirely on a client device, client application 115 sends a message to user datastore 117 to remove the event object. In the case of a social calendar implemented using a remote datastore, browser application 125 sends a message to network server 130 to remove the particular user event object data from user datastore 135 or user datastore 140. In this case, network server front-end 132 receives the user request information, processes the user request by sending a message to user datastore 135 or user datastore 140. Network server front-end 132 receives a confirmation message from the appropriate datastore once the event object data is removed from the appropriate datastore, and forwards the confirmation message to browser application 125. The flowchart of FIG. 4B then continues to step 440 where the flowchart ends.

Input is received to change an event object at step 430. Input may be received to change an event object by user selection of an existing object in a calendar interface. The input may select the event object and then an entry within a drop down menu associated with the event object, a double-click of the object or some other input. Next, updated event object data is received at step 432. Similar to step 412 discussed above, the updated event object data may be received through an interface provided in response to selection of the event object. In one embodiment, updated event object data may include changing existing data, adding missing data, or removing existing data in the interface. After the updated event object data is received at step 432, the updated event object data is saved at step 434. Similar to step 414 discussed above, saving updated event object data may include storing the object data on a local or remote datastore. In addition to saving the event object data, the updated event object is provided in the appropriate calendar interface view. The flowchart of FIG. 4B then ends at step 440.

FIG. 5 is a flowchart of an embodiment of a process for adjusting a calendar view. In one embodiment, the flowchart at FIG. 5 provides more detail of step 380 of FIG. 3. First, input selecting a calendar view is received at step 510. The input may be received through a calendar interface. In one embodiment, the input may be received as a selection of a type of view within a view menu. A view menu is illustrated in the exemplary calendar interfaces of FIGS. 6-9. In other embodiments, the input may be associated with changing parameters for the current interface. For instance, the hours associated with a particular primary day may be changed in the current interface. Thus, a timeline associated with a Saturday and Sunday may be extended from 10 a.m.-9 p.m. to 10 a.m.-11 p.m.

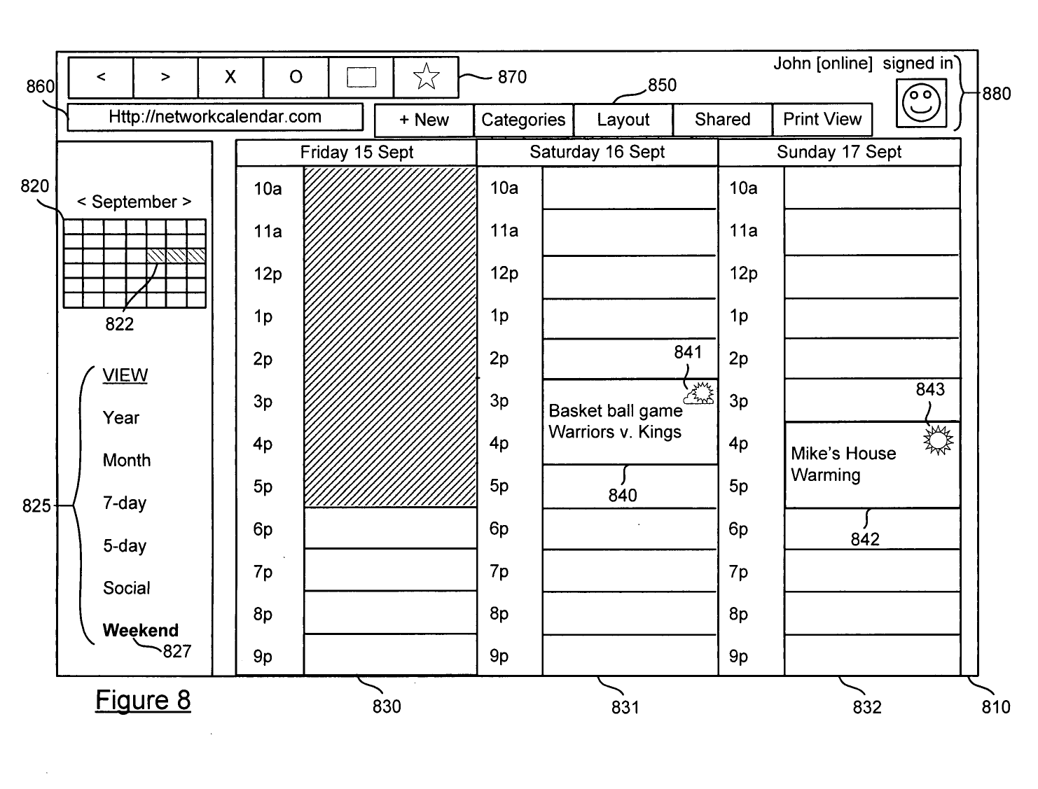

After receiving input, user data associated with the selected interface view is retrieved at step 520. The retrieved user data may include event objects, user parameters and other data, and is associated with the interface view selected at step 510. In one embodiment, the selected interface view will be associated with certain days and certain times for each day. In this case, the request will include parameters which specify the days and times for each day for which data is requested. The datastore receiving the request retrieves the user data that match the request. For example, if the selected view is one weekend view such as that illustrated in FIG. 8, the request sent would specify user data for the hours of 6 p.m. through 10 p.m. on Friday September 15 and 10 a.m. through 10 p.m. for Saturday and Sunday, September 16 through September 17.

In the case of a social calendar implemented on a client device, user datastore 117 receives the request from client application 115. In the case of social calendar implemented over a network, network server front-end 132 receives the request and forwards the request to either user datastore 135 or user datastore 140. The receiving user datastore retrieves the data and provides a response containing the data to network server front end 132. The response is then forwarded by network server front end 132 to browser application 125.

The selected calendar view is constructed at step 530. In this case, the days and timelines associated with each day are provided in the calendar interface. The constructed calendar may be a new calendar view or a modified calendar view, depending on the input received at step 510. Examples of calendar interface views are illustrated in FIGS. 6-9. Once the selected calendar view is constructed, the constructed view is populated with the retrieved user data at step 540. In this case, a constructed calendar view is populated with event objects retrieved at step 520. The event objects are displayed as visual indicators within the calendar interface. For example, for a calendar object associated with a dinner at 8 p.m. on Wednesday, September 13, a visual indicator will be displayed in a calendar interface at a time slot associated with this day and time. This is illustrated in the calendar interface of FIG. 6 and discussed in more detail below. The indicator may provide summary information associated with the event. Upon user selection of the visual indicator, more detail can be provided regarding the particular event object. The additional detail may include additional meta-data associated with the event object which is not displayed in the calendar interface indicator.

The present technology provides for a social calendar provided by an application. The calendar provides information associated with events outside the typical business time periods. In particular, the calendar provides social events during typical social periods. FIGS. 6-9 provide examples of a social calendar interface provided by a calendar application. Though the social calendar interfaces are discussed as being provided by client application 115 or browser application 125 of FIG. 1, any of the interfaces illustrated within FIGS. 6-9 can be provided by either application. The social calendar interfaces are intended as examples only, and other interface or modifications to the illustrated interfaces are considered within the scope of the present technology.

FIG. 6 is an example of a social calendar interface for a user. In one embodiment, interface 610 of FIG. 6 may be implemented as calendar interface 118 provided by client application 115 of FIG. 1A. Interface 610 includes month icon 620, view menu 625, secondary scheduling modules 630-633, primary scheduling modules 634-636, and tool bar 650.

Month icon 620 is a visual indicator of the currently viewed month. Month icon 620 includes highlight 622. As the current social calendar interface provides data for an entire week (Monday-Sunday) using scheduling modules 630-636, the corresponding week is highlighted within month icon 620 by highlight 622.

View menu 625 includes a list of user selectable views. View menu 625 includes a year view, month view, seven-day view, five-day view, a social view, and a weekend view. The selected view 627 is “social” view, and is displayed in bold to indicate that the view is currently displayed within interface 610.

Secondary scheduling modules 630-633 are associated with weekdays Monday through Thursday. Each module includes a timeline, one or more timeline entries, and a header. One or more object events may be configured for each timeline entry. In the embodiment illustrated, a timeline entry is associated with each hour. However, timeline entries can be configured to exist at every hour within a timeline, every thirty minutes, every two hours, for an entire day, or some other period of time. For example, for secondary scheduling module 630, the timeline includes spans a time period of 5 p.m. to 9 p.m. in one hour intervals. The timeline entries are associated with each hour in the timeline. The module header indicates that secondary scheduling module 630 is associated with Monday, September 11. Secondary scheduling module 630 also includes event object 642. Event object 642 is associated with the 8:00 timeline entry and provides information that the event object is associated with an “Art Class” appointment. In secondary scheduling module 632, associated with Wednesday September 13, event object 644 is displayed in the timeline entry associated with 8 p.m. The displayed event object provides information as “Dinner at Ted's.”

Upon user selection of event object 642, event object 644, or any other event object in a calendar interface, more information may be provided regarding the event object. In one embodiment, a second interface may be provided with more information. For example, when event object 642 with timeline entry information of “Art Class” is selected, an interface may be provided which indicates the name of the class (“Art Class”), detailed time information, the class location (for example, address and room number), and other meta-data associated with the class.

Primary scheduling modules 634-636 are associated with consecutive days Friday through Sunday of the highlighted week within month icon 620. Similar to the secondary scheduling modules, each primary scheduling module includes a timeline, a timeline entry and a header. In the embodiment shown, each primary scheduling module has a timeline which lists one hour intervals from 10 a.m. to 9 p.m. A timeline entry is provided at each hour interval for each primary scheduling module. The heading for each primary scheduling module indicates the current day and date for each primary day (e.g., Friday, September 15 through Sunday, September 17). In primary scheduling module 635, associated with Saturday September 16, event object 646 is displayed in timeline entries associated with 3 p.m. and 4 p.m. The displayed event object 646 provides information as “Basketball game Warriors v. Kings.” Similarly, in primary scheduling module 632, associated with Sunday, event object 648 is displayed in timeline entries associated with 4 p.m. and 5 p.m., and provides information of “Mike's House Warming.”

In the social view illustrated in FIG. 6, primary scheduling modules 634-636 have more scheduling bandwidth than secondary scheduling modules 630-634. In particular, primary scheduling modules 634-636 include a timeline which covers more hours (10 a.m.-9 p.m.) in each respective day then secondary scheduling modules 630 -34 (5 p.m.-9 p.m.). Additionally, only hours typically associated with social time periods are provided for scheduling. Typical business hours of 9 a.m. up until 5 p.m. are not displayed within secondary scheduling blocks 630-633 associated with typical business days Monday through Thursday. Additionally, these hours are displayed as shaded, or “unavailable,” in primary scheduling block 634 associated with Friday.

Tool bar 650 includes several buttons allowing a user to configure interface 610 and event objects within interface 610. In particular, tool bar 650 includes buttons associated with a “new” calendar object, “categories” configuration, calendar “layout,” “shared” event objects and “print view.” The “new” button allows a user to generate new event objects. Generation of a new event object is discussed in more detail above with respect to the flowchart of FIG. 4B. The “categories” button allows a user to view event objects associated with one or more categories. In this way, a user can filter the view to display certain types of events. Examples of categories include dinner events, sporting events, birthday events, party events, wedding events, and other events. The “layout” button allows a user to configure the layout of the calendar. The “shared” button allows a user to view event objects which are shared with another user. In one embodiment, the view event objects button is used when the social calendar is used with a remote server. The “print view” button allows a user to an image of the calendar as it will appear when printed.

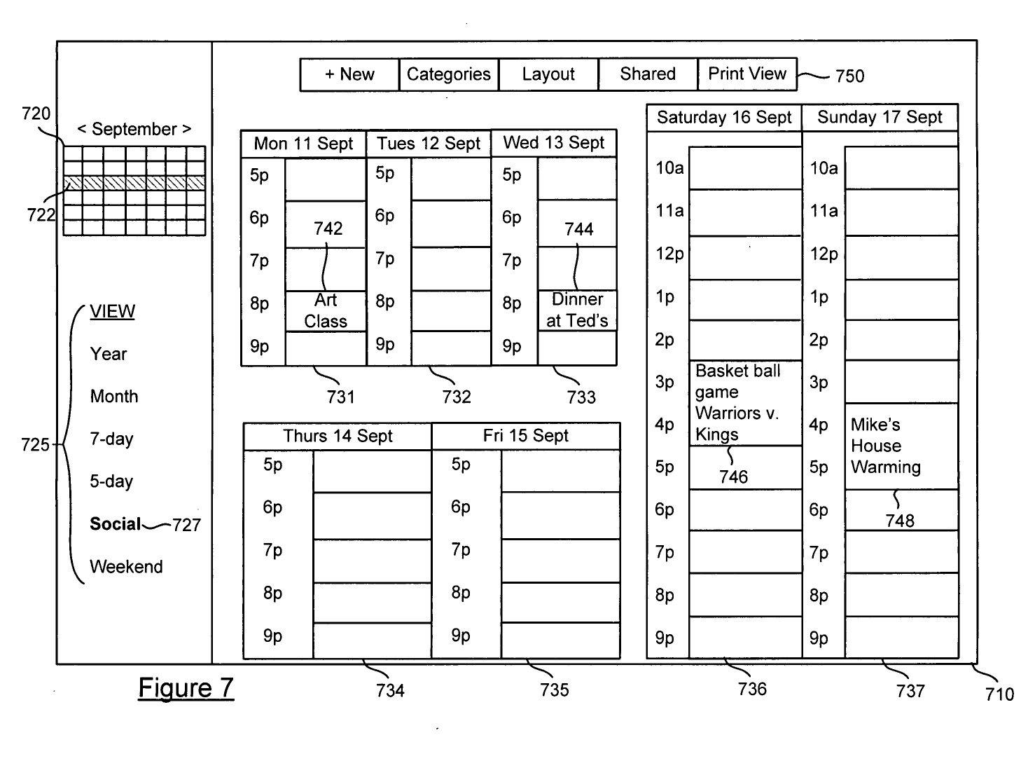

FIG. 7 is an example of an interface for a social calendar. In one embodiment, interface 710 of FIG. 7 may be implemented as calendar interface 118 provided by client application 115 of FIG. 1A. The social calendar of FIG. 7 provides social scheduling information for a week. Interface 710 includes month icon 720, view menu 725, secondary scheduling modules 731-735, primary scheduling modules 736-737, and tool bar 750. In one embodiment, month icon 720, view menu 725 and tool bar 750 are similar to those described above with respect to interface 610 of FIG. 6.

Secondary scheduling modules 731-735 within interface 710 are similar to those discussed above with respect to interface 610 of FIG. 6. In particular, each of secondary scheduling modules 731-735 includes a timeline, timeline entries and a header. However, the scheduling module associated with “Friday” within the displayed week of interface 710 differs than that of interface 610. In particular, primary scheduling module 634 associated with “Friday” in interface 610 is displayed as secondary scheduling module 735 in interface 710. Thus, instead of displaying Friday as a primary scheduling module with only a portion of the day (the portion associated with social time) open for scheduling, the day is associated with a secondary scheduling module.

Interface 710 of FIG. 7 includes event objects similar to those illustrated and discussed above with respect to interface 610 of FIG. 6. In particular, event objects 742, 744, 746 and 748 of interface 710 are similar to event objects 642, 644, 646 and 648, respectively, of interface 610.

FIG. 8 is an example of an interface for a social calendar. In one embodiment, interface 810 of FIG. 8 may be implemented as calendar interface 128 provided by browser application 125 of FIG. 1B. Interface 810 in FIG. 8 includes month icon 820, view menu 825, primary scheduling modules 830-832, tool bar 850, URL address block 860, navigation bar 870 and user information 880. In one embodiment, tool block 850 of interface 810 is similar to tool block 610 discussed above with respect to interface 610.

The social calendar of FIG. 8 provides scheduling information for a weekend. As such, month icon 820 includes a highlight 822 of three days. The three highlighted days correspond to Saturday and Sunday, as well as the preceding Friday. View menu 825 includes the same list of views as view menu 625 of interface 610. However, highlighted view 827 indicates the current view is a “weekend” view rather than a “social” view as highlighted in interface 610.

The three highlighted days of month icon 820 correspond to primary scheduling modules 830-832. Primary scheduling modules 830-832 are associated with Friday, September 15 through Sunday, September 17, per the header in each module. In particular, primary scheduling modules 830-832 of interface 810 are similar to primary scheduling modules 634-636 of interface 610. Unlike interface 610 of FIG. 6, interface 810 does not contain any secondary scheduling modules.

Primary scheduling modules 830-832 contain event objects 840 and 842. Event objects 840-842 are similar to event objects 646-648 discussed above with respect to FIG. 6 except that event objects 840-842 include event parameter indicators 841 and 843, respectively. Event parameter indicators provide supplemental information regarding an event object, such as weather information, travel information, and/or other information. For example, event parameter indicators 841-843 provide weather information for the particular event object. Event parameter indicator 841 includes a sun and clouds corresponding to a “partly sunny” forecast. Event parameter indicator 843 includes a sun corresponding to a “sunny” forecast. The weather information is associated with the current weather forecast for the particular day and event object location. In one embodiment, the weather information may be retrieved by browser application 125 from a network based weather server (not shown in FIG. 1B) over network 150. In another embodiment, the weather information is retrieved by network server 130 and inserted into the content page or other data from which browser application 125 constructs calendar interface 128. In any case, the weather information may be retrieved by accessing time and location data from the event object data and sending a weather forecast request to the network-based weather service. In some embodiments, other event parameter information may be retrieved over network 150 and displayed within an event object within social calendar interface 810.

As discussed above, interface 810 is provided by browser application 125. In one embodiment, URL address block 860 and navigation bar 880 are similar to those typical featured in browser applications. URL address block 860 provides the current URL from which browser application 125 accesses the content page having interface 810. In one embodiment, the URL address block is associated with network server 130 providing the social calendar data over network 150. Navigation bar 880 includes navigation buttons for browsing network 150. Exemplary navigation buttons include back, forward, refresh, stop and favorites.

User information 880 includes information associated with a user who is logged into network server 130. User information 880 includes a user name, user viewed status, user actual status and a user icon. The user name is displayed as “John.” The user viewed status is displayed to other users logged into the network server. The user's viewed status is displayed as “online,” but may be displayed as invisible, away, or some other text string. The user's actual status is currently “signed in,” and user's icon is an icon selected by the user which may be displayed by the user when the user is signed in and not displayed as “invisible.”

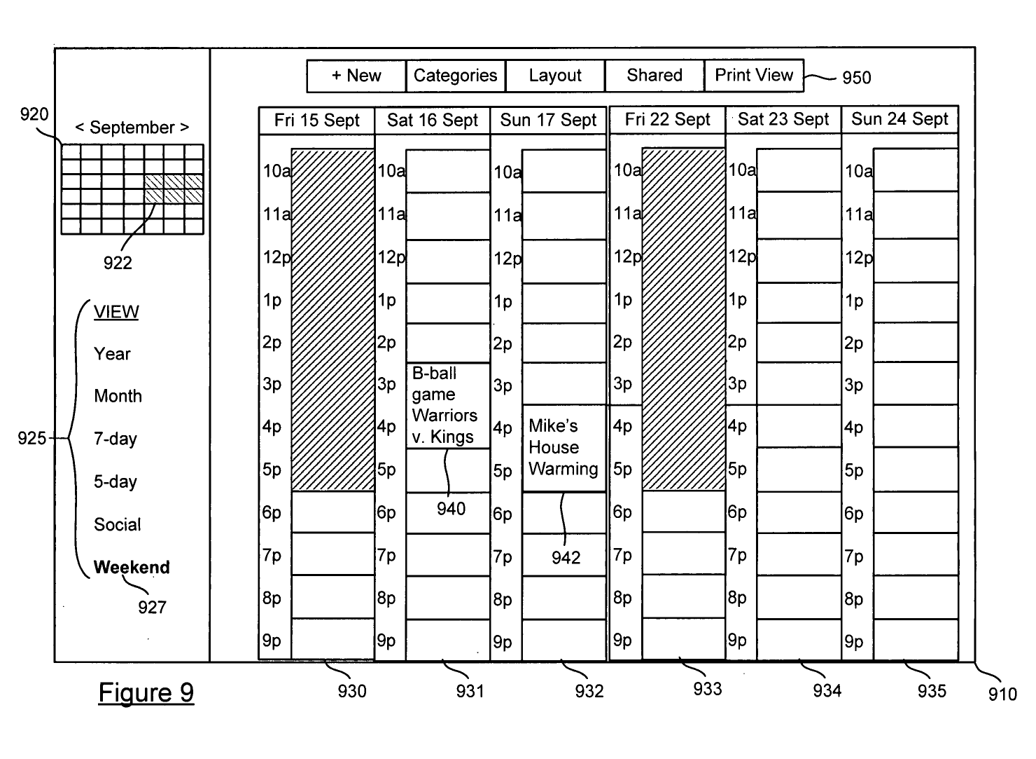

FIG. 9 is an example of an interface for a social calendar. In one embodiment, interface 910 of FIG. 9 may be implemented as calendar interface 118 provided by client application 115 of FIG. 1A. The social calendar of FIG. 9 provides social scheduling information for a two consecutive weekends. Interface 910 includes month icon 920, view menu 925, primary scheduling modules 930-935, and tool bar 950. Interface 910 does not contain secondary scheduling modules. In one embodiment, tool bar 950 of interface 910 is similar to tool bar 650 of interface 610 described above with respect of FIG. 6.

Month icon 920 is similar to month icon 620 of FIG. 6. Highlight 922 differs from highlight 622 of FIG. 6 in that two consecutive sets of Fridays through Sundays (two sets of three consecutive days) are highlighted by highlight 922 of FIG. 9. View menu 925 includes the same list of views as view menu 625 of FIG. 6. However, highlight 927 highlights a “weekend” view.

Primary scheduling modules 930-935 within interface 910 are similar to those discussed above with respect to interface 610 of FIG. 6. In particular, each of primary scheduling modules 930-935 includes a timeline, timeline entries and a header. However, primary scheduling modules 930-935 of FIG. 9 are associated with two consecutive weekend periods consisting of a Friday through Sunday. In particular, primary scheduling modules 930-935 are associated with Friday, September 15 through Sunday, September 17 and Friday, September 22 through Sunday, September 24, respectively. Scheduling modules associated with the intervening days Monday, September 18 through Thursday, September 21 are not provided. This allows a user to focus on the social periods of consecutive weekends.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A method for providing a calendar, comprising:
providing a primary scheduling module for each of two or more primary consecutive days within an interface associated with a calendar; and
providing a secondary scheduling module for each of two or more secondary consecutive days within the interface,
the two or more primary scheduling modules associated with a larger scheduling bandwidth than the two or more secondary scheduling modules, the two or more primary scheduling modules and the two or more secondary scheduling modules associated with social time periods.

2. The method of claim 1, wherein each of the two or more primary scheduling modules includes more timeline entries within the interface than each of the two or more secondary scheduling modules.

3. The method of claim 1, wherein each of the two or more primary scheduling modules includes more space within the interface than each of the two or more secondary scheduling modules.

4. The method of claim 1, further comprising:
selecting a view from a view menu, the two or more primary scheduling modules and two or more secondary scheduling modules are provided in response to selection of the view.

5. The method of claim 1, further comprising:
providing an event object within the interface, the event object associated with a social event and displayed within one of the two or more primary scheduling modules or two or more secondary scheduling modules.

6. The method of claim 1, wherein said step of providing a primary scheduling module and said step of providing a secondary scheduling module are performed by a client application.

7. The method of claim 1, further comprising:
authenticating a user, wherein said step providing a primary scheduling module and providing a secondary scheduling module are performed in response to said step of authenticating a user.

8. The method of claim 7, wherein said step of authenticating a user includes:
receiving authentication information from a user; and
sending an authentication request to a remote network server.

9. The method of claim 1, wherein the social time periods include evenings of a weekday.

10. The method of claim 1, wherein the social time periods include a weekend day.

11. One or more processor readable storage devices having processor readable code embodied on said processor readable storage devices, said processor readable code for programming one or more processors to perform a method comprising:
providing a first module for each of two or more primary consecutive days within an interface provided by a calendar application; and
providing a second module for each of two or more secondary consecutive days within the interface,
the two more primary consecutive days are not consecutive with the two or more secondary consecutive days, the two or more first modules and two or more second modules associated with non-working periods of time.

12. The one or more processor readable storage devices according to claim 11, further comprising:
selecting a view from a view menu, the first modules and second modules provided in response to selection of the view.

13. The one or more processor readable storage devices according to claim 12, further comprising:
retrieving user data from a remote server in response to said step of selecting the view.

14. The one or more processor readable storage devices according to claim 12, further comprising:
retrieving user data from local memory in response to said step of selecting the view.

15. The one or more processor readable storage devices according to claim 11, further comprising:
receiving event object data through the interface, the event object data associated with a social event which occurs during one of the primary consecutive days or secondary consecutive days.

16. The one or more processor readable storage devices according to claim 11, wherein the two or more primary consecutive days and two or more secondary consecutive days are corresponding days in different weeks.

17. An apparatus for processing data, comprising:
a communication interface;
a storage device; and
one or more processors in communication with said storage device and said communication interface, said one or more processors perform a method comprising:
providing a plurality of modules within an interface, each module associated with a day and a time period within the day, at least one of the plurality of modules associated with a work day, the time period for each of the plurality of modules associated with a non-working period for the day associated with the module; and
providing an event object in one of the plurality of modules, the event object associated with a social event and having a time parameter within the non-working period for the day associated with the module.

18. The apparatus of claim 17, wherein the one or more modules associated with a work day have less scheduling bandwidth than the one or more modules not associated with a work day.

19. The apparatus of claim 17, wherein the event object includes an event parameter indicator which provides supplemental information associated with the event object, the supplemental information retrieved from a first remote network server.

20. The apparatus of claim 17 further comprising:
storing event object data at a second remote network server located at a different location then the first remote network server.
